(19) United States
(12) Patent Application Publication
(10) Pub. No.: US 2015/0234194 A1
(43) Pub. Date: Aug. 20, 2015

(54) Projecting Kaleidoscope

(71) Applicant: SKINA OPTICAL CO., LTD., New Taipei City (TW)

(72) Inventors: I-HSIUNG CHOU, New Taipei City (TW); WEN-NAN CHEN, New Taipei City (TW)

(21) Appl. No.: 14/330,308

(22) Filed: Jul. 14, 2014

(30) Foreign Application Priority Data
Feb. 14, 2014 (TW) 103104958

(51) Int. Cl. G02B 27/08; G03B 21/28

(52) U.S. Cl. CPC G02B 27/08; G03B 21/28

(57) ABSTRACT

A projecting kaleidoscope includes a main body with a light source, an assembly of reflector/refractor optics and a projecting assembly intervening between the assembly of reflector/refractor optics and the main body. A diffuser of the projecting assembly may make the light beams homogeneous from the light source and improve the brightness quality of kaleidoscope patterns when they are projected outside of the projecting kaleidoscope.

### BACKGROUND OF THE INVENTION

1. Field of the Invention

The present invention relates generally to kaleidoscope, and particularly relates to projecting kaleidoscope.

2. Description of Related Art

People are attracted to various changeable patterns shown by a traditional optical toy of kaleidoscope. Generally, a user only observes the pattern of a small size in the traditional kaleidoscope. Accordingly, U.S. Pat. No. 4,077,706 discloses a projecting kaleidoscope to project the pattern of the kaleidoscope out. However, it is necessary to improve the quality of the projected pattern.

FIG. 1 is a pattern shown in a traditional kaleidoscope. When such a pattern is projected out of the kaleidoscope, there are different brightness represent on the projected pattern. Particularly, the boundaries or interfaces 1 of the pattern represent lower brightness. It is easy for people to resolve the drawback aforementioned by providing the light source to irradiate higher brightness light to pass the pattern. However, the light source irradiating the higher brightness light does not efficiently improve the lower brightness among the boundaries or interfaces. Moreover, it does not save cost to design a device equipped with a light source to irradiate the higher brightness light with higher power.

### SUMMARY OF INVENTION

In order to overcome the drawbacks aforementioned, a projecting kaleidoscope is provided herein, which includes a light source and a diffuser configured to treat the light from the light source for improving the drawback of low brightness among the boundaries or interfaces of a pattern of the projecting kaleidoscope.

In order to overcome the drawbacks aforementioned, a projecting kaleidoscope is provided herein, which includes the detachable and assemble members to change different patterns easily to be projected for a user.

In order to overcome the drawbacks aforementioned, a projecting kaleidoscope is provided herein, which includes at least one rotatable member for the user to conveniently act on the rotatable member of the projecting kaleidoscope for the purpose of rotating the pattern plate within the projecting kaleidoscope.

Accordingly, a projecting kaleidoscope device includes: a main body; a light source within the main body; an assembly of reflector and/or refractor optics deposited on the main body; and a projecting assembly between the main body and the assembly of reflector and/or refractor optics, wherein the projecting assembly includes a pattern plate and a diffuser, and light derived from the light source irradiates out of the projecting kaleidoscope after passing through the diffuser, the pattern plate and the assembly of reflector and/or refractor optics in sequence.

Preferably, the projecting assembly further comprises a rotating member and a translucent film, the pattern plate movable and changeable within a space defined by the diffuser and the translucent film, and the rotating member rotatable relative to the assembly of reflector and/or refractor optics or the main body.

Preferably, the size of the pattern plate is smaller than the one of the diffuser or the translucent film, and the rotating member is manually or electrically rotatable.

Preferably, the translucent film has a pattern distributed the whole or partial thereon.

Preferably, the projecting assembly further includes a translucent box defining a space and deposited onto the diffuser, the pattern plate is movably and changeably deposited within the space of the translucent box, and the translucent box is rotatable relative to the assembly of reflector and/or refractor optics or the main body; or the projecting assembly further includes a translucent box which the diffuser is regarded as a first cover thereof and a space is formed therewithin, the pattern plate is movably and changeably deposited within the space of the translucent box, and the translucent box is rotatable relative to the assembly of reflector and/or refractor optics or the main body.

Preferably, the size of the pattern plate is smaller than the one of the diffuser or the translucent box, and the translucent box is manually or electrically rotatable.

Preferably, the translucent box further includes a second cover defining the space with the first cover, and the second cover includes a pattern distributed the whole or the partial the second cover.

Preferably, the projecting kaleidoscope further includes a reflective cup around the light source and deposited within the main body, wherein the reflective cup is located between the light source and the diffuser.

Preferably, the assembly of reflector and/or refractor optics comprises: a barrel; a plurality of reflective mirrors in a triangle arrangement within the barrel; a plurality of fixing members to fix the reflective mirrors within the barrel; and a lens within or on the barrel which the light derived from the light source further passes through to irradiate out of the projecting kaleidoscope.

Preferably, a primary or secondary battery is deposited within the main body.

Preferably, a power port for alternative or direct current is deposited on the main body.

Preferably, the projecting kaleidoscope is equipped with wired or wireless power.

Accordingly, a projecting kaleidoscope includes a main body; a light source within the main body; a barrel on the many body, wherein the barrel is a part of an assembly of reflector and/or refractor optics and comprises a lens at a first end thereof; and a projecting assembly between the main body and a second end of the barrel, wherein the projecting assembly includes a pattern plate and a diffuser, and light derived from the light source irradiates out of the projecting kaleidoscope from the first end of the barrel after passing through the diffuser, the pattern plate and the assembly of reflector and/or refractor optics and the lens in sequence, and the projecting assembly is capable of rotating relative to the main body and the barrel.

Preferably, the projecting assembly is manually rotatable and further comprises: a rotating member detachably coupling to a first end of the main body; and a translucent film and the diffuser positioned between the first end of the main body and the rotating member, wherein a space is defined by the diffuser and the translucent film, and the pattern plate is movably and changeably deposited within the space.

Preferably, the translucent film has a pattern distributed the whole or partial thereon.

Preferably, the projecting kaleidoscope further includes an electrical assembly, the electrical assembly configured to rotate the projecting assembly, wherein the projecting assembly comprises a translucent box consisted of two translucent covers and a sidewall between the two translucent covers, and the pattern plate is movably and changeably deposited within the translucent box.

Preferably, the electrical assembly comprises: a driving member positioned within the main body; a pivoting member pivoted by the driving member, wherein the pivoting member touched the sidewall of the translucent box and the translucent box is driven by the pivoting member in pivot to rotate; and a supporting member positioned between the barrel and the main body, wherein the translucent box is rotatably and detachably mounted on the supporting member.

Preferably, a power port for alternative or direct current is deposited on the main body.

Preferably, a primary or secondary battery is deposited within the main body.

Other objects, features and advantages of the present invention will become apparent upon inspection of the detailed description of the preferred embodiments herein below taken in conjunction with the drawings figures.

### BRIEF DESCRIPTION OF THE DRAWINGS

FIG. 1 is a pattern shown in a traditional kaleidoscope.

FIG. 2 is an exemplary schematic diagram illustrating a first projecting kaleidoscope in accordance with the present invention.

FIG. 3 is a schematic explosive diagram illustrating the first projecting kaleidoscope in accordance with the present invention.

FIG. 4 is a schematic cross-sectional diagram illustrating the first projecting kaleidoscope in accordance with the present invention.

FIG. 5 is a schematic diagram illustrating the second projecting kaleidoscope in accordance with the present invention.

FIG. 6 is a top-side three-dimensional diagram illustrating a projector assembly and an electrical assembly of the second projecting kaleidoscope in accordance with the present invention.

FIG. 7 is a bottom-side three-dimensional diagram illustrating the projector assembly and the electrical assembly of the second projecting kaleidoscope in accordance with the present invention.

FIG. 8 is a bottom-side three-dimensional diagram illustrating the projector assembly and the partial electrical assembly of the second projecting kaleidoscope in accordance with the present invention.

### DESCRIPTION OF THE PREFERRED EMBODIMENT

The present projecting kaleidoscope may be equipped with a power supply to provide power for rotation or other functions. The power may be wired or wireless supplied for the projecting kaleidoscope from an exterior power source. In the case of wired power supply, the projecting kaleidoscope may include one or more USB ports, direct current ports or alternative current ports. Alternatively, the power supply may be a primary or secondary battery deposited within the projecting kaleidoscope, such as one or more dry cells or rechargeable battery. An exemplary wireless power supply, not limited to, such as inductive power or magnetic power supply.

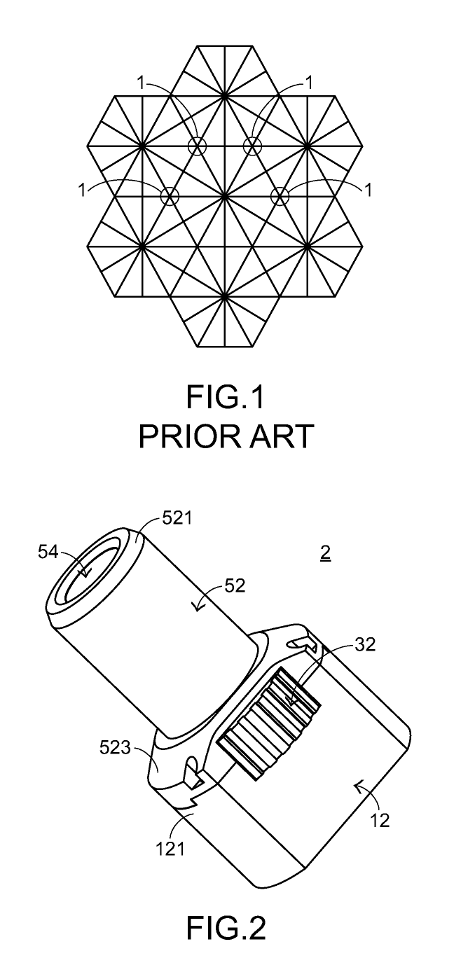

FIG. 2 is an exemplary schematic diagram illustrating a first projecting kaleidoscope in accordance with the present invention. Referring to FIG. 2, a projecting kaleidoscope 2 includes a main body 12, a rotating member 32 and a barrel 52. The first end 521 of the barrel 52 is equipped with a lens 54. The first end 121 of the main body 12 and the second 523 of the barrel 52 are detachably matched and fixed with each other, and the rotating member 32 is positioned between the main body 12 and the barrel 52. In the first embodiment, the partial surface of the rotating member 32 is exposed to the outside of the barrel 52 and the main body 12 to be configured for a user to operate the rotating member 32 with a hand.

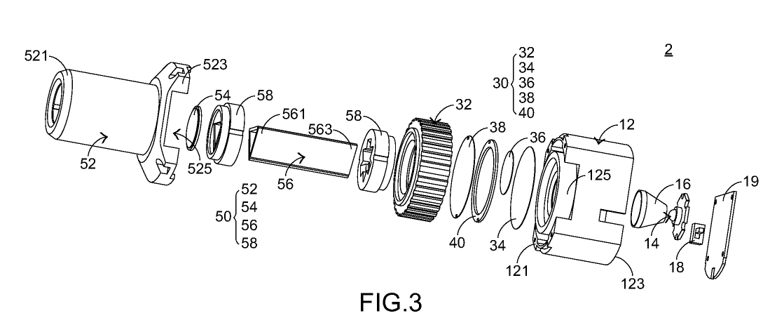

FIG. 3 is a schematic explosive diagram illustrating the first projecting kaleidoscope in accordance with the present invention. Referring to FIG. 3, an assembly of reflector and/or refractor optics 50 is deposited on the main body 12, which includes the barrel 52, a lens 54, a reflective mirror 56 and one or more fixing members 58. In the first embodiment, the lens 54, multitudes of the reflective mirrors 56 and multitudes of the fixing members 58 are positioned within the barrel 52. At least two reflective mirrors 56 are in a triangle arrangement, and the fixing members 58 are respectively positioned the first end 561 and the second end 563 of the triangle consisting of the reflective mirrors 56. With the engagement of the fixing members 58, the first end 561 of the reflective mirrors 56 is fixed to the first end 521 of the barrel 52, and the second end 563 of the reflective mirrors 56 is fixed close to the second end 523 of the barrel 52. The fixing members 58 are fixed within the barrel 52 in the ways of engagement or joint, but not limited to aforementioned.

Next, in the first embodiment, a projecting assembly 30 is positioned between the main body 12 and the assembly of reflector and/or refractor optics 50. The exemplary projecting assembly 30 includes a rotating member 32, a diffuser 34, a pattern plate 36, a translucent film 38 and a base plate 40. Furthermore, the diffuser 34, a pattern plate 36, the translucent film 38 and the base plate 40 are positioned within the rotating member 32. Their combination will be illustrated later. Next, the rotating member 32 may be sleeved onto the sleeve part 125 of the first end 121 of the main body 12.

Next, a light source 14 is positioned within the main body 12. The exemplary light source 14 may include a light emitting diode and the circuit associated therewith. A reflective cup 16 may be located around the light emitting diode. Light derived from the light source 14 irradiates out of the projecting kaleidoscope 2 from the assembly of reflector and/or refractor optics 50 and the lens 54, after passing through the diffuser 34, the pattern plate 36 and the assembly of reflector and/or refractor optics 50 and the lens 54 in sequence. In the case of the projecting kaleidoscope 2 equipped with the light source 14, the main body 12 may includes a power switch 18 and other controls for the control of the light source 14. Next, the main body 12 further includes a base 19 for loading the light source 14. The first end 121 of the main body 12 may include a suitable structure capable of matching and fixing with the second end 523 of the barrel 52.

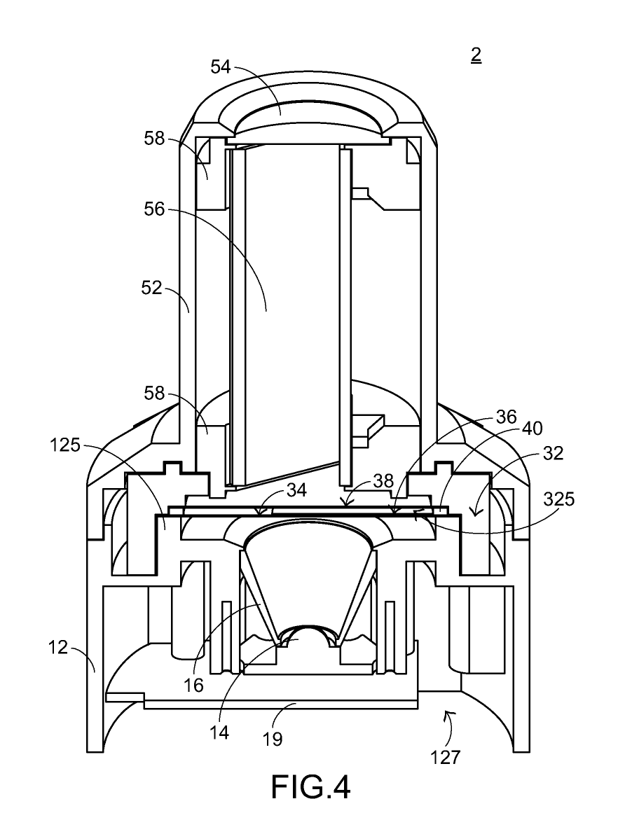

FIG. 4 is a schematic cross-sectional diagram illustrating the first projecting kaleidoscope in accordance with the present invention. Please refer to FIGS. 2-4, in the first embodiment, the rotating member 32 of the projecting assembly 30 is a ring member and includes multitudes of protrusions on an inner sidewall for positioning the diffuser 34, translucent film 38 and a base plate 40. The diffuser 34, the translucent film 38 and a base plate 40 may be fixed by the sleeve part 125 of the main body 12 sleeved with the rotating member 32. The manual rotating member 32 may be rotated relative to the assembly of reflector and/or refractor optics 50, the barrel 52 or the main body 12. The ring base plate 40 is located between the diffuser 34 and the translucent film 38 to define space 325 where the diffuser 34 and the translucent film 38 are deposited in, but not limited to. The ring base plate 40 may be replaced by the protrusions on the inner sidewall of the rotating member 32 for defining the space 325. Accordingly, when a user holds the main body 12 or the barrel 52 and rotates the rotating member 32, the pattern plate 36 within the space 325 may be driven to rotate or move by a force. The rotated pattern plate 36 may produce a variety of patterns under the light derived from the light source 14. Furthermore, since the main body 12 and the barrel 52 are detachable, the user may replace the pattern plate 36 in the rotating member 32 easily by taking the rotating member 32 out of the projecting kaleidoscope. Thus, the exchangeable pattern plate 36 is achieved for the projecting kaleidoscope in the present invention.

Further, the translucent film 38 may have a pattern distributed the whole or partial thereon. Thus, a pattern combination of the translucent film 38 and the pattern plate 36 may be acquired, and more different patterns may be acquired by the relative movement of the translucent film 38 and the pattern plate 36 in rotation. In the first embodiment, both of the translucent film 38 and the pattern plate 36 are circular positive pattern film, and the size of the translucent film 38 is bigger than the one of the pattern plate 36, but not limited to. When the rotating member 32 is rotated, the translucent film 38 fixed to the rotating member 32 may be consistent with the rotating member 32, but the movement of the pattern plate 36 may be not consistent with the rotating member 32 because of its smaller size within the relative bigger space 325. Accordingly, more and more patterns are acquired and changeable. It is noted that multitudes of the pattern plates 36 may be positioned within the space 325 to achieve the generation of various patterns.

It is understood that the light derived from the light source 14 may irradiate out the projecting kaleidoscope to project the pattern plate 36 to outside, after passing through the diffuser 34, the pattern plate 36 or the translucent film 38. Thus, the diffuser 34, the pattern plate 36 or the translucent film 38 is translucent in the present invention. Next, the diffuser 34 may be located close to the light source 14 to diffuse the light derived from the light source 14 and enhance the light homogeneousness behind the pattern plate 36 and the translucent film 38. Accordingly, the homogeneousness of the light passing through the assembly of reflector and/or refractor optics 50 may be improved compared to a traditional projecting kaleidoscope, especially the brightness homogeneousness among the boundaries or interfaces of a projected pattern. Thus, the pattern projection in good quality is achieved in the present invention. In the first embodiment, the diffuser 34, not limited to, is formed by coating or pressing non-regular structures on a PET translucent base.

It may be acknowledged that the higher brightness of light source would improve the drawbacks of lower brightness among the boundaries or interfaces for a projected kaleidoscope pattern. However, it is not economic for the projecting kaleidoscope to be equipped with a high power light source. Besides, in practice, the lower brightness of the boundaries or interfaces of the pattern may be not efficiently improved by the use of higher power light source. Thus, the use of the diffuser in the present invention may not only save the energy consumption but also improve the quality of the projected pattern. Moreover, the position of the diffuser closest to the light source is advantageous to treat the light homogeneous before the light passes through the pattern plate to efficiently improve the lower brightness among the boundaries or interfaces, when compared to another position for setting the diffuser. Next, the interior space provided by the projecting kaleidoscope is restricted by the size of the projecting kaleidoscope for the user to hold, which also restricts any member or component to be installed within the projecting kaleidoscope as well. However, the addition of a diffuser within the projecting kaleidoscope in the present invention is still advantageous that the positioning of the diffuser and the assembly convenience for the projecting kaleidoscope are considered in the present invention, as well as the quality enhancement of the projected pattern.

Besides, in the restricted space 127 provided by the main body 12, the reflective cup 16 may be installed around the light emitting diode of the light source 14 to increase the light amount passing through the diffuser 34. Next, a power supply member like a primary or secondary battery (not shown) may be deposited within the space 127 for providing the light source 14 with the power.

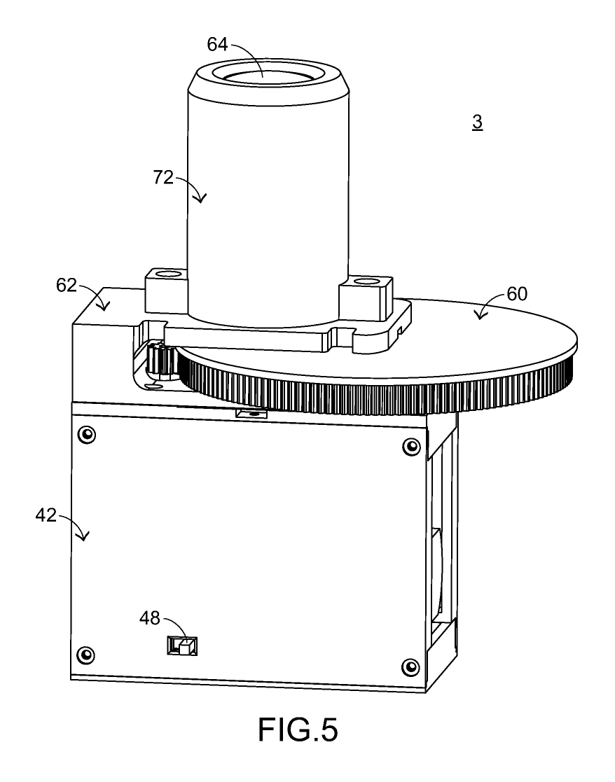

FIG. 5 is a schematic diagram illustrating the second projecting kaleidoscope in accordance with the present invention. The second projecting kaleidoscope 3 includes a barrel 72, a projecting assembly 60, an electrical assembly 62 and a main body 42. The projecting assembly 60 and the electrical assembly 62 are positioned between the barrel 72 and the main body 42. In the second embodiment, the barrel 72 is fixed to the electrical assembly 62 and a lens 64 is deposited at the end of the barrel 72, and the electrical assembly 62 is fixed onto the main body 42. The projecting assembly 60 is detachably and movably mounted onto the electrical assembly 62. Next, a power switch 48 is mounted onto the main body 42, which is turned on to rotate the electrical assembly 62 and the projecting assembly 60.

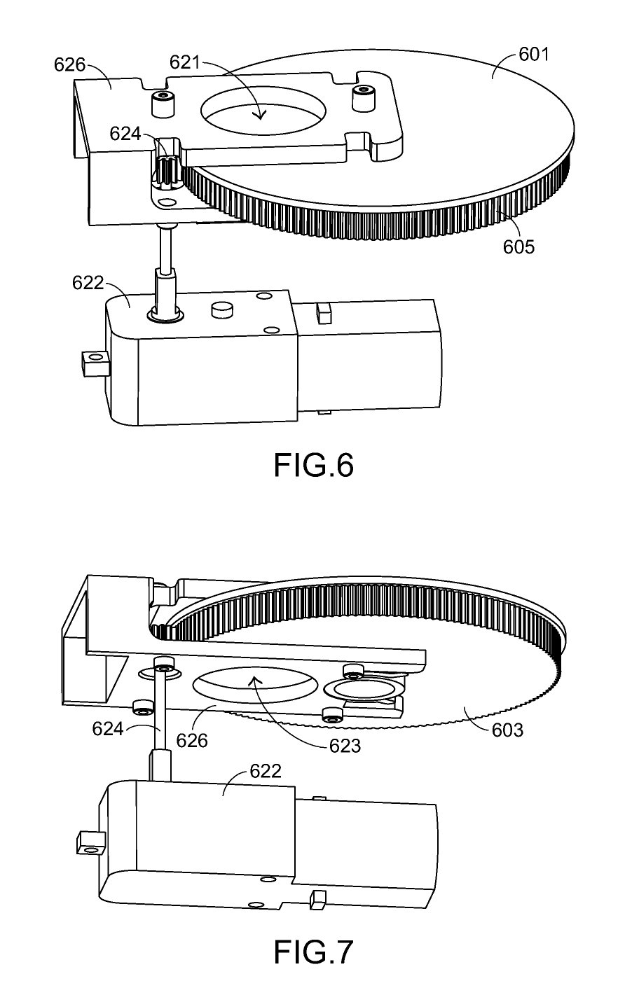

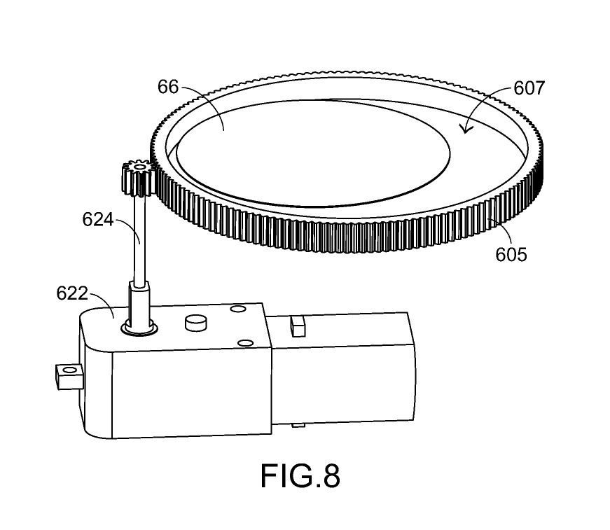

FIG. 6 is a top-side three-dimensional diagram illustrating a projector assembly and an electrical assembly of the second projecting kaleidoscope in accordance with the present invention. FIG. 7 is a bottom-side three-dimensional diagram illustrating the projector assembly and the electrical assembly of the second projecting kaleidoscope in accordance with the present invention. FIG. 8 is a bottom-side three-dimensional diagram illustrating the projector assembly and the partial electrical assembly of the second projecting kaleidoscope in accordance with the present invention. Referring to FIGS. 5-8, the projecting assembly 60 includes a translucent box that has a first and a second covers 603, 601 and a sidewall 605. The first and second covers 603, 601 are cooperated with the sidewall 605 to define space 607. In the second embodiment, the pattern plate 66, the first and the second covers 603, 601 are in round shapes. Both the radiuses of the first and the second covers 603, 601 are bigger than one of the pattern plate 66, so that the pattern plate 66 are movable and changeable within the space 607. Besides, in the case of the first cover 603 near the side of the light (not shown) source within the main body 42, the first cover 603 may be a diffuser to make the light from the light source homogeneous after the light passes through the first cover 603. Alternatively, a diffuser (not shown) and the pattern plate 66 are put in the space 607, and they have similar sizes to be not movable within the space 607. Alternatively, a diffuser (not shown) is set on the main body 42 and between the translucent box and the light source. Furthermore, the second cover 601 is translucent and may have a pattern distributed the whole or partial thereon.

Next, the electrical assembly 62 includes a driving member 622, a pivoting member 624 and a supporting member 626. The driving member 622, the pivoting member 624 and the portion of the supporting member 626 are positioned within the main body 42, and the supporting member 626 may be matched with the main body 42. The driving member 622, such as a motor, is configured to drive the pivoting member 624 to rotate, and the sidewall 605 of the projecting assembly 60 in touch with the pivoting member 624 is driven to be rotated. Moreover, the projecting assembly 60 of the translucent box is rotatably and detachably mounted on the supporting member 626. The supporting member 626 has hollow portions 621, 623 corresponding to the light source within the main body 42, such that the light derived from the light source within the main body 42 irradiates out of the projecting kaleidoscope after passing through the hollow portion 623, the diffuser (not shown), the pattern plate 66, the hollow portion 621 and the assembly of reflector and/or refractor optics (including the barrel 72) and out from the lens 64 of the assembly of reflector and/or refractor optics.

While the present invention has been shown and described herein what are considered to be the preferred embodiments thereof, illustrating the results and advantages over the prior art obtained through the present invention, the invention is not limited to those specific embodiments. Thus, the forms of the invention shown and described herein are to be taken as illustrative only and other embodiments may be selected without departing from the scope of the present invention, as set forth in the claims appended hereto.

What is claimed is:

1. A projecting kaleidoscope device, comprising:
a main body;
a light source within the main body;
an assembly of reflector and/or refractor optics deposited on the main body; and
a projecting assembly between the main body and the assembly of reflector and/or refractor optics, wherein the projecting assembly includes a pattern plate and a diffuser, and light derived from the light source irradiates out of the projecting kaleidoscope after passing through the diffuser, the pattern plate and the assembly of reflector and/or refractor optics in sequence.

2. The projecting kaleidoscope according to claim 1, wherein the projecting assembly further comprises a rotating member and a translucent film, the pattern plate movable and changeable within a space defined by the diffuser and the translucent film, and the rotating member rotatable relative to the assembly of reflector and/or refractor optics or the main body.

3. The projecting kaleidoscope according to claim 2, wherein the size of the pattern plate is smaller than the diffuser or the translucent film, and the rotating member is manually or electrically rotatable.

4. The projecting kaleidoscope according to claim 2, wherein the translucent film has a pattern distributed the whole or partial thereon.

5. The projecting kaleidoscope according to claim 1, wherein
the projecting assembly further includes a translucent box defining a space and deposited onto the diffuser, the pattern plate is movably and changeably deposited within the space of the translucent box, and the translucent box is rotatable relative to the assembly of reflector and/or refractor optics or the main body; or
the projecting assembly further includes a translucent box which the diffuser is regarded as a first cover thereof and a space is formed therewithin, the pattern plate is movably and changeably deposited within the space of the translucent box, and the translucent box is rotatable relative to the assembly of reflector and/or refractor optics or the main body.

6. The projecting kaleidoscope according to claim 5, wherein the size of the pattern plate is smaller than the one of the diffuser or the translucent box, and the translucent box is manually or electrically rotatable.

7. The projecting kaleidoscope according to claim 5, wherein the translucent box further includes a second cover defining the space with the first cover, and the second cover includes a pattern distributed the whole or the partial the second cover.

8. The projecting kaleidoscope according to claim 1, further comprising a reflective cup around the light source and deposited within the main body, wherein the reflective cup is located between the light source and the diffuser.

9. The projecting kaleidoscope according to claim 1, wherein the assembly of reflector and/or refractor optics comprises:
a barrel;
a plurality of reflective mirrors in a triangle arrangement within the barrel;
a plurality of fixing members to fix the reflective mirrors within the barrel; and
a lens within or on the barrel which the light derived from the light source further passes through to irradiate out of the projecting kaleidoscope.

10. The projecting kaleidoscope according to claim 1, further comprising a primary or secondary battery deposited within the main body.

11. The projecting kaleidoscope according to claim 1, further comprising a power port for alternative or direct current deposited on the main body.

12. The projecting kaleidoscope according to claim 1, wherein the projecting kaleidoscope is equipped with wired or wireless power.

13. A projecting kaleidoscope, comprising:
a main body;
a light source within the main body;
a barrel on the many body, wherein the barrel is a part of an assembly of reflector and/or refractor optics and comprises a lens at a first end thereof; and
a projecting assembly between the main body and a second end of the barrel, wherein the projecting assembly includes a pattern plate and a diffuser, and light derived from the light source irradiates out of the projecting kaleidoscope from the first end of the barrel after passing through the diffuser, the pattern plate and the assembly of reflector and/or refractor optics and the lens in sequence, and the projecting assembly is rotated relative to the main body and the barrel.

14. The projecting kaleidoscope according to claim 13, wherein the projecting assembly is manually rotatable and further comprises:
a rotating member detachably coupling to a first end of the main body; and
a translucent film and the diffuser positioned between the first end of the main body and the rotating member, wherein the diffuser together with the translucent film define a space, and the pattern plate is movably and changeably deposited within the space.

15. The projecting kaleidoscope according to claim 14, wherein the translucent film has a pattern distributed the whole or partial thereon.

16. The projecting kaleidoscope according to claim 13, further comprising an electrical assembly, the electrical assembly configured to rotate the projecting assembly, wherein the projecting assembly comprises a translucent box consisted of two translucent covers and a sidewall between the two translucent covers, and the pattern plate is movably and changeably deposited within the translucent box.

17. The projecting kaleidoscope according to claim 16, wherein the electrical assembly comprises:
a driving member positioned within the main body;
a pivoting member pivoted by the driving member, wherein the pivoting member touches the sidewall of the translucent box and the translucent box is driven by the pivoting member in pivot to rotate; and
a supporting member positioned between the barrel and the main body, wherein the translucent box is rotatably and detachably mounted on the supporting member.

18. The projecting kaleidoscope according to claim 13, further comprising a power port for alternative or direct current deposited on the main body.

19. The projecting kaleidoscope according to claim 13, further comprising a primary or secondary battery deposited within the main body.
